(19) United States
(12) Patent Application Publication
(10) Pub. No.: US 2023/0196527 A1
(43) Pub. Date: Jun. 22, 2023

(54) Removing Clarity Issues From Images To Improve Readability

(71) Applicant: PayPal, Inc., San Jose, CA (US)

(72) Inventor: Jiyi Zhang, Singapore (SG)

(21) Appl. No.: 17/645,484

(22) Filed: Dec. 22, 2021

(51) Int. Cl. G06T 5/50; G06V 30/12; G06T 7/00

(52) U.S. Cl. CPC G06T 5/50; G06V 30/133; G06T 7/0002

(57) ABSTRACT

Techniques are disclosed relating to methods that include receiving, by a computer system, a plurality of images of an object taken from a video during which there is relative movement between the object and a camera that captures the video. The method may further include in response to determining that the video does not include a single image that meets a clarity threshold for the object, creating, by the computer system, a merged image of the object by combining portions of different images of the plurality of images such that the clarity threshold for the object is satisfied by the merged image. The method may also include capturing, by the computer system, information about the object using the merged image.

### BACKGROUND

### Technical Field

This disclosure relates generally to digital image processing, and more particularly to techniques for improving clarity of characters within an image.

### Description of the Related Art

Images of documents and other objects with included text, such as identification cards, may be used as a method for entering text by some applications. For example, in some applications, a picture may be taken of a gift card in order to enter the card information for use. In such cases, the gift card may include a series of ten or more alphanumeric characters that identify and link the gift card to a specific value. Some users, such as those with poor eyesight, may have difficulty reading the characters. Taking a picture of the card and then recognizing and capturing the code from the image may improve the experience for the user as well as reduce an amount of time the user spends redeeming the gift card.

Clarity issues, such as glare from a light source in a room where a photograph of the gift card is taken or a flash from the camera used to take the photograph, may present difficulties for collecting information from a captured image. Glare located on top of text can make the text illegible, causing a failure to recognize the information on the card, and thereby require the user to repeat the photographing process. Repetition of the photographing process may, in addition to causing frustration to the user, result in increased power consumption in the user's device used to take the photographs, as well as a waste in network bandwidth if the application on the user's device sends misread information to a networked service related to the gift card.

### BRIEF DESCRIPTION OF THE DRAWINGS

FIG. 1 is a block diagram illustrating an embodiment of a system for capturing information from a series of images.

FIG. 2 shows a block diagram of an embodiment of a system that identifies regions within images that include clarity issues.

FIG. 3 depicts an example of an embodiment of a system aligning two different images of a same object.

FIG. 4 illustrates another example of an embodiment of a system aligning two different images of a same object using portions of text recognized in the object.

FIG. 5 shows an example of a system capturing video of an object.

FIG. 6 depicts an example of how a clarity issue may be located in different areas of an object within different frames of a video of the object.

FIG. 7 illustrates a flow diagram of an embodiment of a method for capturing information from a merged image created from a plurality of images from a video.

FIG. 8 shows a flow diagram of an embodiment of a method for identifying clarity issues in a plurality of images and creating a merged image from the plurality of images to improve clarity of text identified within the images.

FIG. 9 depicts a flow diagram of an embodiment of a method for capturing a video of an object from which information will be captured.

FIG. 10 is a block diagram illustrating an example computer system, according to some embodiments.

### DETAILED DESCRIPTION

As disclosed above, clarity issues may present difficulties for collecting information from a photographed image. As used herein, a “clarity issue” refers to any obscurity in a digital image that prevents a clear view of an object in the image. Text in the image may be obscured, causing a failure to recognize the information in the image, and thereby requiring a new photograph to be taken. Repetition of the photographing process may waste power in a user's device, as well as waste network bandwidth if misread information is transferred to a different computer system.

The present disclosure recognizes that if video, rather than a single image, is used to capture text from an object such as an identification card or other object, then clarity issues, such as glare, may be in different locations in different images from the video. Movement by a user during the image capturing process may result in glare, or other clarity issues, occurring in different regions of the object during the different images of the video. Various images may then be analyzed and compared to a clarity threshold for the object. Two or more frames may be aligned such that text that is illegible due to glare in one image may be legible in a different frame. be merged to generate a clarified image of the object with legible text. An optical character recognition (OCR) algorithm may then be used to retrieve information from the object.

By using a video clip in place of a single photo to capture images of an object that includes text, obstructions to clarity, such as glare, may be in different regions of the object in the different frames, thereby increasing chances that the text can be deciphered successfully in a single attempt, thereby reducing use of system resources and increasing the bandwidth of the system to perform other functions.

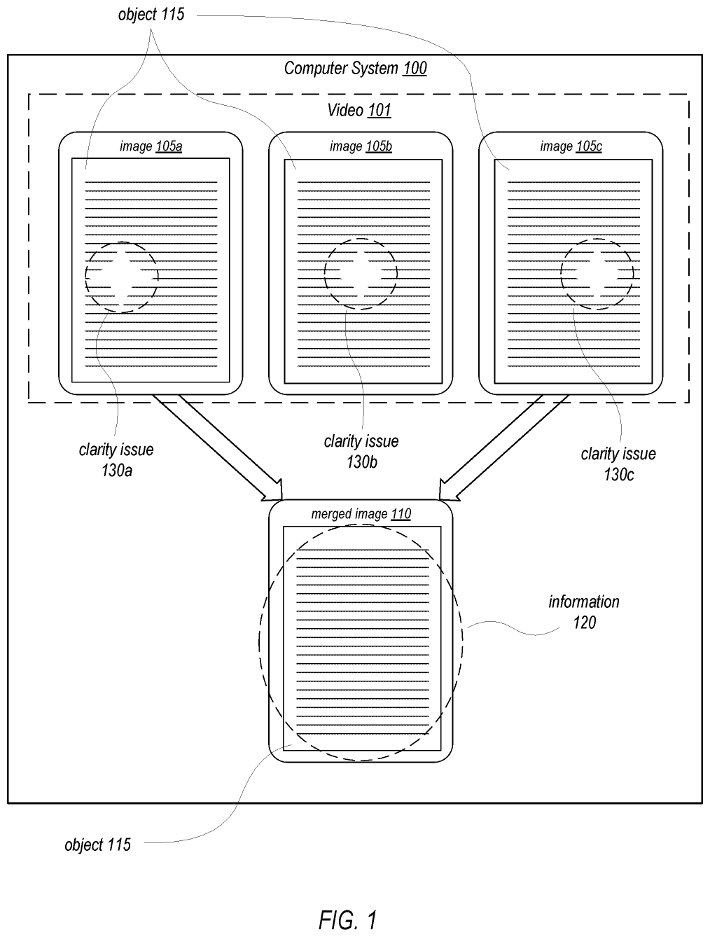

A block diagram of an embodiment of a computer system that may be used to implement the disclosed techniques is illustrated in FIG. 1. As illustrated, computer system 100 depicts an example of merged image 110 being created from images 105a-105c (collectively images 105) from video 101. Computer system may correspond to any suitable type of computer system, including, for example, a desktop computer, a laptop computer, a smartphone, a tablet computer, and the like. In some embodiments, computer system 100 may be a server computer system configured to host some or all of a web service.

As shown, computer system 100 receives images 105 of object 115 taken from video 101. During capture of video 101, there is relative movement between object 115 being captured and a camera that captures the video. The camera that captures the video may, in some embodiments, be included in computer system 100, while in other embodiments, a separate device with a camera is used to capture video 101 and send video 101 to computer system 100. Video 101 includes a series of digital images 105 that correspond to subsequent points in time from a previous image. For example, image 105a may be an image captured at a first point in time, followed be image 105b and then 105c, each image taken a predetermined amount of time after the other.

Computer system 100, as illustrated, analyzes a clarity of object 115 within images 105. In response to determining that video 101 does not include a single image 105 that meets a clarity threshold for object 115, computer system 100 creates merged image 110 of object 115 by combining portions of images 105a and 105c of images 105 such that the clarity threshold for object 115 is satisfied by merged image 110. Computer system 100 may analyze some or all of images 105, first identifying object 115 within each analyzed one of images 105 and then determining if a clarity issue exist in the image and if this clarity issue meets a clarity threshold for object 115. A clarity issue may include various ways in which object 115 is obscured, at least in part, such that the corresponding image 105 does not depict all visible details of object 115. For example, clarity issues may include glare reflected off of the object, an out of focus image, a shadow cast on the image, and the like.

As depicted in FIG. 1, each of images 105a-105c include a respective sub-threshold clarity issue 130. As can be seen, clarity issues 130a-130c (e.g., glare reflected from object 115) move across object 115 in each subsequent image 105. In image 105a, clarity issue 130a is on the left side of object 115. Clarity issue 130b is located towards the center of object 115 in image 105b, while clarity issue 130c is on the right side of object 115 in image 105c. This movement may be caused by movement of the camera relative to object 115, by movement of a light source relative to the camera and/or object 115, by movement of object 115 relative to the camera, or a combination thereof. To create merged image 110, two or more of images 105 are selected, and pixel data in the areas of the clarity issues is merged and/or replaced with corresponding pixel data from another image 105 that meets the threshold level of clarity in the same area. As shown, images 105a and 105c are selected for use to generate merged image 110.

To create merged image 110, computer system 100 may use pixel data from image 105c to modify or replace pixel data in image 105a that is determined to be obscured by clarity issue 130a. Similarly, pixel data from image 105a may be used to modify or replace pixel data in image 105c that is associated with clarity issue 130c.

After the creation of merged image 110, computer system 100 captures information 120 about object 115 using merged image 110. For example, object 115 may include text that is captured using optical character recognition techniques. In other embodiments, information 120 may include data encoded into non-text symbols, such as a bar code or a quick response (QR) code. In some embodiments, information 120 may include distinguishing characteristics of a human face, animal, vegetation, or the like. After capturing information 120, computer system 100 may use information 120 to perform a particular task such as data entry or a web search. In other embodiments, computer system 100 may send information 120 to a different computer system to be processed. In cases in which text or symbols are recognized, creating merged image 110 may include increasing a level of contrast between pixels with light image data and pixels with dark pixel data. Contrast between pixels may be prioritized over preserving color information, in order to make characters and/or symbols easier to recognize.

By using a plurality of images rather than a single image to capture an object, clarity issues, such as glare, may move across the object in the different images, thereby increasing chances that portions of information to be captured from the object meet a threshold level of clarity in at least one image of the plurality. The increased chance of capturing desired information from the object in a single attempt may, in turn reduce use of processing bandwidth of computer system 100, freeing computer system 100 to perform other functions, as well as avoiding frustration of a user having to repeat attempts to capture a clear image of the object.

It is noted that the embodiment of FIG. 1 is merely an example. Features of the system have been simplified for clarity. In other embodiments, additional elements may be included, such as a camera circuit to capture images 105, and/or a screen on which to display captured images. Although images 105 are shown as being part of video 101, other methods for capturing a sequence of images are contemplated. For example, some camera circuits may be optionally configured to capture a plurality of still images in response to a single trigger.

As disclosed in FIG. 1, a computer system is described as merging two or more images to create a single merged image. Various techniques may be utilized to create the merged image. One such technique is described in the following figure.

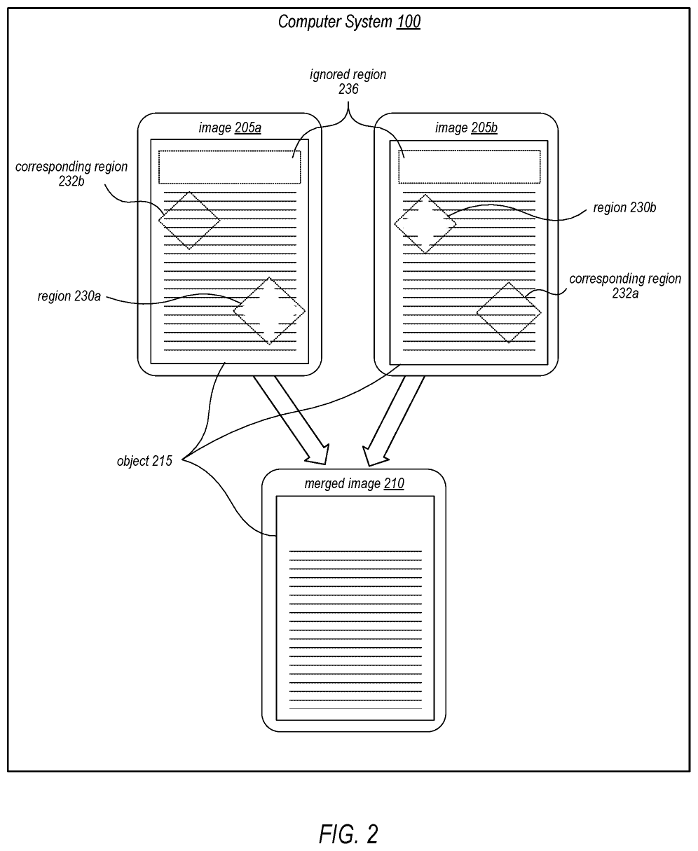

Moving to FIG. 2, another embodiment of the computer system of FIG. 1 is depicted in which the computer system identifies a region in a first image that corresponds to a region in a second image that includes a clarity issue, and vice versa. As illustrated, computer system 100 has captured a series of two images of object 215, image 205a and image 205b. Images 205a and 205b each have a respective region (regions 230a and 230b) that includes a clarity issue. FIG. 2 illustrates an example of how computer system 100 creates merged image 210 that reduces the clarity issues such that all regions of merged image 210 satisfy a threshold level of clarity.

As illustrated, creating merged image 210 includes identifying, by computer system 100, a first clarity issue in region 230a of image 205a, and similarly identifying a second clarity issue in region 230b of image 205b. As depicted in FIG. 2, region 230b is in a different location of object 215 than region 230a. In some embodiments, determining a level of clarity within regions 230a and 230b includes identifying glare reflected off of object 215 within regions 230a and 230b. Glare may be determined, for example, by identifying pixels within regions 230a and 230b that satisfy a threshold level of saturation. Formats for pixel data may vary in different embodiments. For example, in some embodiments, saturation may be an independent value and, therefore, computer system 100 may identify glare by comparing saturation values for pixels of images 205a and 205b to a threshold value of saturation. Any pixel with a saturation value above the threshold value may be logged as saturated. In some embodiments, a particular number of pixels within a particular region may need to be logged as saturated before a clarity issue is determined for that particular region.

After regions 230a and 230b have been determined as including clarity issues, computer system 100 may identify a second image of the series of images in which the level of clarity of the object within a first corresponding region meets the threshold level of clarity. As shown, for example, corresponding region 232a of image 205b depicts a same area of object 215 as region 230a. Corresponding region 232a, however, meets the threshold clarity level. In a similar manner, corresponding region 232b of image 205a depicts a same area of object 215 as region 230b, and also meets the threshold clarity level.

In some embodiments, identifying clarity issues in regions 230a and 230b includes determining, by computer system 100, whether the given region includes text. Computer system 100 may ignore a given region in response to determining that no text is included in the given region. For example, regions 230a and 230b are illustrated as covering an area that includes text (represented by the lines within object 215. Regions 230a and 230b may be determined to be covering areas of text based on comparisons with the corresponding regions 232a and 232b, respectively. In other embodiments, regions 230a and 230b may be determined to be covering areas of text based on a text recognition process that recognizes characters and then interprets consecutive strings of characters as words. If text strings leading into and/or out of regions 230a and 230b are not discernable as known words, and the regions have been identified as having saturated pixels, then regions 230a and 230b are determined to have clarity issues that obscure text. Ignored region 236, on the other hand, does not have recognized characters in either of images 205a or 205b, and therefore may be ignored for the purpose of resolving clarity issues, regardless of pixel data in this region.

Computer system 100, as shown, creates merged image 210 by merging region 230a of image 205a with corresponding region 232a of image 205b, and merging region 230b of image 205b with corresponding region 232b of image 205a. Merging the various regions may include, for example, combining, in merged image 210, corresponding pixel data for each pixel in corresponding region 232a with pixel data for each respective pixel in region 230. In various embodiments, combining pixel data may correspond to replacing pixel data in region 230 with the respective pixel data from corresponding region 232a. In other embodiments, pixel data in region 230a may be modified using pixel data from corresponding region 232a, for example, by averaging respective pixel data values together.

It is noted that the example of FIG. 2 is merely for demonstrating the disclosed concepts. The elements of FIG. 2 have been simplified for clarity. For example, text in objects is depicted as lines and clarity issues as white space over the lines. In other embodiments, actual text may be included and clarity issues may appear as marks other than whitespace. Although a series of only two captured images is shown, any suitable number of images may be captured and used to generate the merged image.

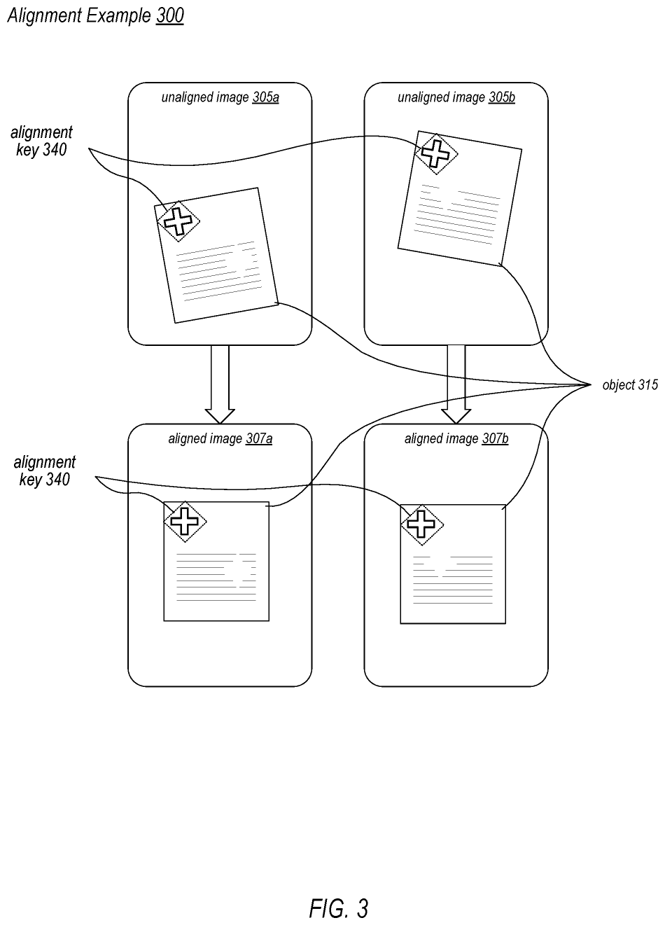

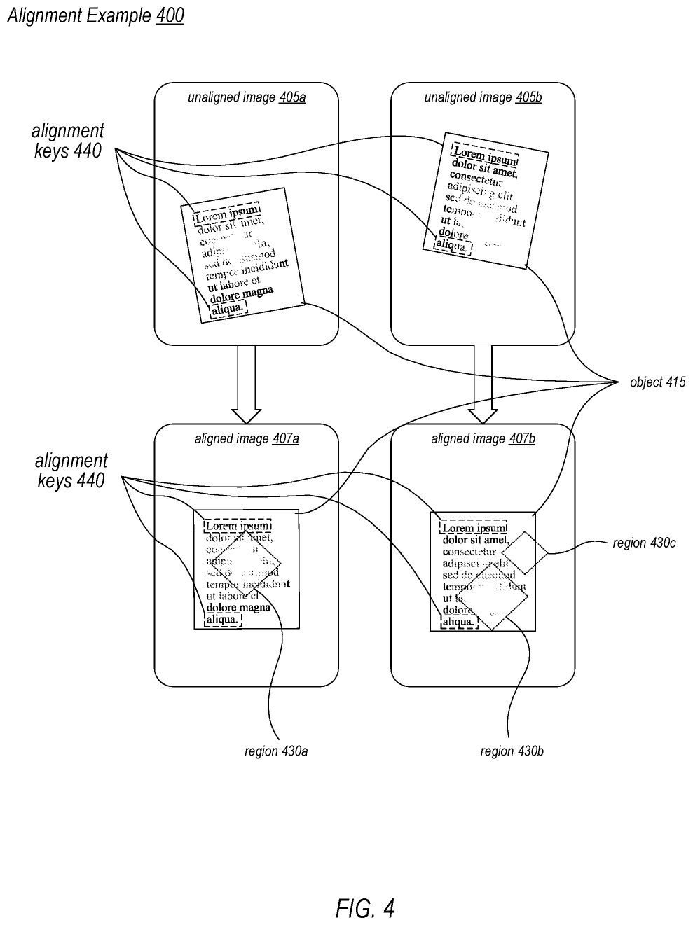

In FIG. 2, corresponding regions are identified in different images. In order to identify a region in a second image that corresponds to an image in a first image, an identifiable object in each image may need to be located in order to align the object in each image. FIGS. 3 and 4 depict such techniques.

FIG. 3 illustrates an example of aligning an object appearing in a series of two or more different images. As described above, if a region with a clarity issue is found in one image, then a second image without a clarity issue in the corresponding region is sought. The series of images, however, may be taken with different camera angles as the camera and/or object may move relative to each other while the series of images (e.g., individual frames of a video) are captured. Accordingly, a process is desired that aligns the object within each image such that common regions of the object can be located in each aligned image. Alignment example 300 includes unaligned images 305a and 305b that capture object 315 at two different angles.

A technique is described to identify and use alignment key 340 on object 315, and then perform, by a computer system such as computer system 100, one or more alignment operations to align object 315 in the different images. Alignment key 340 may be any uniquely identifiable shape found within images to be aligned. In alignment example 300, object 315 includes a plus sign/cross shape in the top left corner. Various characteristics may be evaluated by computer system 100 to select a shape as alignment key 340. For example, a shape that appears only once on object 315 may be preferred over a repeated shape. The shape may also be preferred to have adjacent pixels with high levels of contrast (e.g., sharp edges) that may enable more accuracy when identifying an orientation of object 315 in each image. Alignment key 340 may further be selected based on asymmetry around various axes. For example, a square may be preferable to a circle, while a rectangle may be preferable to a square. The cross symbol may be selected in unaligned images 305a and 305b due to an acceptable level of contrast, its placement in a corner of object 315, and lack of clarity issues around the cross symbol in both unaligned images 305. In some cases, a portion of a shape may be selected if the shape is obscured in one or more of the unaligned images. For example, a corner of a photo or drawing included on an object may be selected.

After a particular shape has been selected as alignment key 340, computer system 100 may, in some embodiments, determine horizontal (‘x’) and vertical (‘y’) offsets between alignment key 340 in each of unaligned images 305. In various embodiments, these offsets may be resolved by relocating object 315 in one image to a same x and y location as the other image. As shown, object 315 is relocated from both unaligned images 305a and 305b to a midpoint of the offsets to create aligned images 307a and 307b.

After the x and y offsets are resolved, rotational offsets may be determined. As shown, object 315 in unaligned image 305a is rotated several degrees counter-clockwise, while object 315 is rotated several degrees clockwise in unaligned image 305b. Again, various techniques may be used to align the rotational offsets, such as rotating one image to match the other or adjusting both images using a midpoint of the offsets. In some embodiments, such as shown, each image may be rotated such that edges of object 315 are vertical and horizontal.

After aligned images 307a and 307b have been generated from unaligned images 305a and 305b, respectively, corresponding regions in each aligned image may be located using respective locations of regions with clarity issues in each aligned image 307. A merged image may be possible to generate after images are aligned.

It is noted that alignment example 300 is one example for demonstrating disclosed concepts. Although the alignment process is described using one particular order of procedures, this order may be performed in different orders in various embodiments. For example, rotational offsets may be reduced before x and y offsets.

Turning to FIG. 4, another example for aligning two or more images is shown. In a similar manner as alignment example 300, alignment example 400 starts with a series of two unaligned images 405a and 405b. Object 415 is captured from a different perspective in each of these images. In order to use unaligned images 405a and 405b to generate a merged image with reduced clarity issues, the two images are first aligned such that common regions of object 415 can be determined.

As described for alignment example 300, alignment keys may be used to identify common points within two or more images that may be used to determine x, y, and rotational offsets between the plurality of images. In alignment example 300, object 315 captured in unaligned images 305 included a design element in the form of a cross symbol that was usable as alignment key 340. Object 415 in alignment example 400, however, only includes text. Accordingly, to perform alignment operations to generate aligned images 407a and 407b, one or more portions of same text are identified in unaligned image 405a and 405b.

As illustrated, performing the alignment operations includes performing optical character recognition in unaligned images 405a and 405b to generate character data. The character data may then be used as alignment keys 440 to align object 415 in unaligned images 405a and 405b to the location of the object in the first image. As shown, two sections of text are identified using a character recognition technique such as optical character recognition. The character string “Lorem ipsum” is recognized in the first line of object 415, while “aliqua” is recognized in the last line. These strings are identifiable in both unaligned images 405a and 405b and are, therefore, usable as alignment keys 440. In various embodiments, any suitable number of character strings of any suitable length may be selected for use as alignment keys. After alignment keys 440 are selected, an alignment process as previously described may be performed to generate aligned images 407a and 407b.

In various embodiments, detection of clarity issues may be performed before or after an alignment process is performed. In alignment example 400, aligned images 407a and 407b may be generated first and then clarity issues detected. Determining a level of clarity of different regions of object 415 includes determining if a given region of aligned image 407a or 407b includes text. For example, if an end goal of capturing a clear image of object 415 is to capture text included in object 415, then clarity issues may be of interest if they obscure text. Otherwise, clarity issues obscuring graphics in object 415 may be ignored. Accordingly, indications that a level of clarity of regions 430a and 430b does not meet a threshold level of clarity may be generated in response to determining that there is at least some text in these regions. An indication that a level of clarity of region 430c meets a threshold level of clarity may be generated in response to determining that there is no text in region 430c.

It is noted that FIG. 4 is an example of aligning a plurality of images using a same text string that is recognized in each image. Although the example of FIG. 4 is presented using two unaligned images, any suitable number of images may be included in the alignment process. A particular order of procedures is disclosed in the description of FIG. 4. This order may be different in other embodiments. For example, rotational offsets may be reduced before x and y offsets.

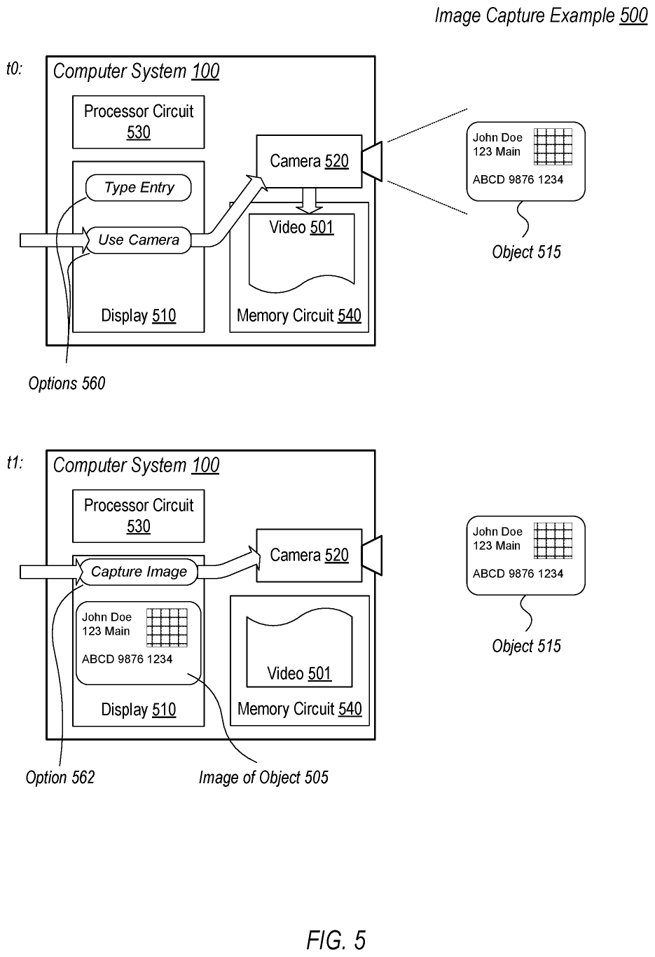

FIGS. 1-4 describe various techniques that may be used for capturing an image of an object. A computer system is described as performing the described techniques. Various embodiments of computer systems may be used to perform the techniques described herein. One such example is shown in FIG. 5.

Proceeding to FIG. 5, an example of a computer system capable of using a camera to capture an image of an object is illustrated. Image capture example 500 depicts how computer system 100 may be used to capture an image of object 515. Computer system 100, as illustrated, includes display 510, camera 520, processor circuit 530, and memory circuit 540. Computer system 100 may be a mobile device such as a smart phone, a tablet computer, a laptop computer, or a smart camera system. In other embodiments, computer system 100 may be a less mobile system such as a desktop computer system or smart appliance. In various embodiments, camera 520 is either included as a component with computer system 100 or is an external component coupled to computer system 100 via a wired or wireless connection (e.g., universal serial bus, Bluetooth™, or the like). An application is running on computer system 100, for example, a non-transitory, computer-readable medium having program instructions stored thereon and executable by processor circuit 530 of computer system 100, may cause operations to be performed as described herein. FIG. 5 depicts operation of computer system 100 at two different points in time. labeled t0 and t1.

As illustrated, camera 520 is any of a variety of camera circuits that include suitable lenses and image sensor circuits for capturing video and still images. Camera 520 is configured to capture a series of images of video 501 of object 515 while there is movement between camera 520 and object 515. The application executed by processor circuit 530 causes options 560 to be displayed on display 510. For example, the application may require a user of computer system 100 to enter information that is included on object 515. Object 515, as shown, is a form of identification (ID) card (e.g., a driver's license, passport, student ID, or the like). In other embodiments, object 515 may be any type of object, such as a credit card, a form document, a product package, a product information plate attached to a product, or any other object with text or other symbols that may include information that the user desires to input into the application. As described above, execution of the application may cause processor circuit 530 to perform various tasks described herein.

Processor circuit 530, as shown, may be any suitable type of processor supporting one or more particular instruction set architectures (ISAs). In some embodiments, processor circuit 530 may be a processor complex that includes a plurality of processor cores. For example, processor circuit 530 may include a plurality of application processor cores supporting a same ISA and, in some embodiments, may further include one or more graphic processing units (GPUs) configured to perform various tasks associated with image files as well as other forms of graphic files (e.g., scalable vector graphics).

At time t0, as shown, camera 520 begins capturing video 501 in response to a selection of an option to enter information via a camera circuit, e.g., the user selecting the “use camera” option of options 560. In response to this selection, the application causes camera 520 to begin capturing video 501. Memory circuit 540 is any suitable type of memory circuit and is configured to receive and store a series of images of video 501.

After time t0, the application may further cause display 510 to display a most recent available frame from video 501 as captured by camera 520. In various embodiments, display 510 may receive a frame of video 501, including image of object 505, from camera 520 or from memory circuit 540. In addition to displaying the recent frame of video 501, the application may also cause display 510 to show option 562 to “capture image.” The capture image option 562, as illustrated, is used by the user to indicate when object 515 is in focus and ready to be photographed. For example, the user may be unaware that video 501 is being captured after the selection of the “use camera” option 560. The user, instead, may assume that a photograph is taken when the “capture image” option 562 is selected. Before the user selects option 562, the user may reposition camera 520 and/or object 515 one or more times in order to get a clear image on display 510. During such repositioning, video 501 may capture multiple frames of object 515 with any clarity issues, such as glare, moving to different regions across object 515 in the different video frames.

The application may cause camera 520 to end capture of video 501, at time t1, in response to the user selecting the “capture image” option 562, the user expecting to take a photo of object 515 with camera 520 at time t1. One or more frames of video 501 may be capture after the user selects option 562 and then camera 520 ceases capturing further frames. A video format file, such as Moving Pictures Experts Group (MPEG) or Audio Video Interleave (avi), for video 501 is closed after the final frame is captured and stored in memory circuit 540.

After time t1, processor circuit 530 is configured to determine a level of clarity of object 515 within individual images of video 501. In some embodiments, processor circuit 530 performs the operations to determine the level of clarity of frames of video 501. Processing the frames of video 501 in computer system 100 may protect the privacy of the user by avoiding sending any portion of video 501 over the internet. Processing locally on computer system 100 may also reduce an amount of time for processing the frames of video 501 since the frames do not have to be transmitted.

In other embodiments, however, processor circuit 530 may send some or all frames of video 501 to an online computer service (not shown) associated with the application to perform some or all of the operations to determine the level of clarity of captured images. For example, the application may provide an interface on computer system 100 to an online server computer (e.g., a social media application). In such embodiments, privacy of the user may be protected by encrypting the frames that are sent to the online computer service.

In response to a determination that individual frames of video 501 fail to meet a threshold level of clarity of object 515, combine portions of two or more of the individual frames to generate a merged image of object 515. Using techniques as described above, processor circuit 530 (or, in other embodiments, an online computer service to which the frames are sent) extracts information about object 515 using the merged image. For example, text and/or encoded symbols included on object 515 may be interpreted and used as input the application, enabling the user to avoid typing the interpreted information into the application.

It is noted that the example of FIG. 5 is presented to demonstrate disclosed concepts. The disclosed example is not intended to be limiting, and, examples of other embodiments may include different elements. For example, image capture example 500 illustrates computer system 100 capturing a series of images as video 501 in one file using a video format. In other embodiments, computer system 100 may capture the series of images as a plurality of still image files, such as Joint Photographic Experts Group (JPEG), Tag Image File Format (TIFF), Portable Network Graphics (PNG), and the like.

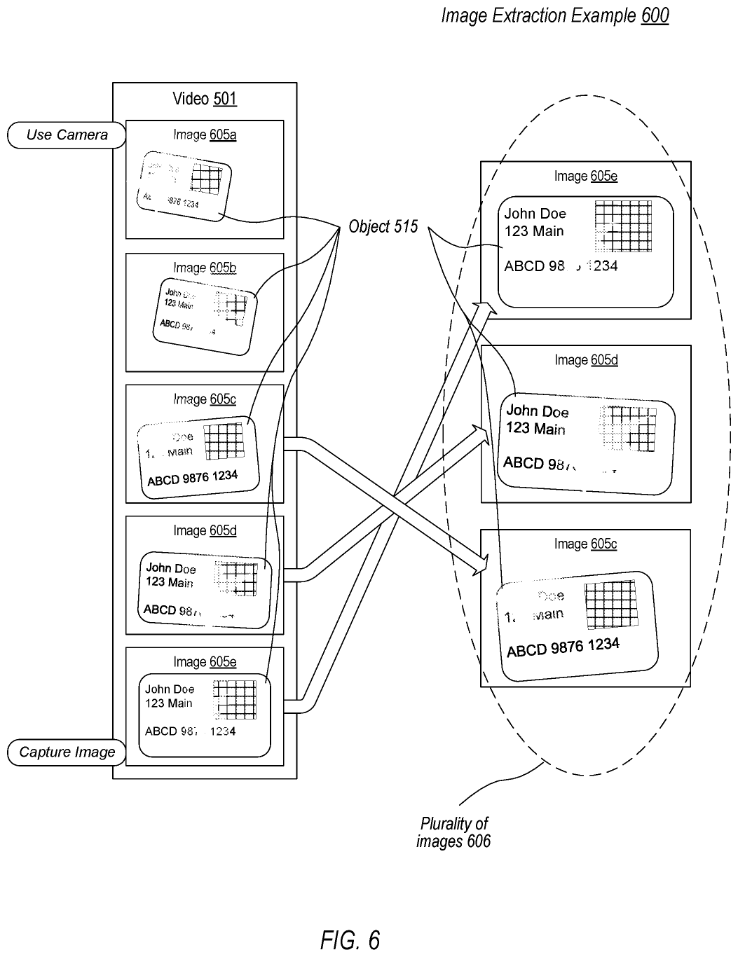

FIG. 5 describes an embodiment that includes capturing images using a video file. Images may be extracted from a video file using a variety of techniques. A particular technique is described in regards to FIG. 6.

Moving now to FIG. 6, an example of a video file that includes a series of images of an object to be interpreted is shown. Image extraction example 600 includes video 501 from FIG. 5 and shows five images 605a to 605e (collectively 605) corresponding to different frames of video 501, each image depicting a different view of object 515. As will be described in more detail below, image extraction example 600 shows how particular ones of images 605 may be selected for inclusion in a plurality of images 606 and extracted for use in the image clarifying techniques disclosed herein.

As disclosed above, operation of the application that captures video 501 may direct a user to focus camera 520 on object 515 in order to capture and interpret information from object 515. In response to the user selecting the “use camera” option displayed by the application, camera 520 begins recording video 501. Image 605a may be the first frame of video captured while image 605e is the last frame of video 501 captured after the user selects the “capture image” option. Multiple images 605 of object 515 may be captured as the user adjusts computer system 100 and/or object 515 for a clear image capture. As shown in image extraction example 600, the user may tilt and/or use a camera zoom function (or physically move the camera) to increase a size of object 515 in the captured images 605. Such movements and changes in perspective may cause a clarity issue in the captured images 605 to move across object 515, thereby obscuring different portions of object 515 in each image 605.

As illustrated, processor circuit 530 of computer system 100 uses last image 605e of video 501 as a first image of plurality of images 606 for extracting information from object 515. Image 605e may be an image captured at a time that is closest to when the user selected the “capture image” option. Accordingly, image 605e may represent what the user believes is a best view of object 515, thereby making image 605e a suitable starting point for the disclosed image clarity improvement technique. Pixel data corresponding to image 605e may be copied from its location in memory circuit 540 into a different memory location for processing. For example, a range of memory locations in memory circuit 540, different from locations used to store video 501, may be allocated for use as an image processing buffer where the copy of image 605e is stored. In other embodiments, a different memory circuit (e.g., in processor circuit 503) may be used for storing the copy of image 605e. For example, computer system 100 may include a graphics processor unit (GPU) with one or more dedicated memory buffers. The copy of image 605e may be placed in such a GPU memory buffer.

Processor circuit 530 may also include one or more previous images 605 from earlier points in video 501 to plurality of images 606. In image extraction example 600, two additional images, 605d and 605c, are added to plurality of images 606. In various embodiments, the additional images 605 may be selected before or after processing of image 605e begins. For example, in some embodiments, image 605c may be selected before processing of image 605e begins, while image 605d may be selected after processing begins, e.g., to provide additional pixel data if necessary to create a clear merged image. Image 605c may be selected based on one or more criteria such as a time difference from when image 605e was captured, an alignment and/or zoom level of object 515 within image 605c as compared with image 605e, a determination of a degree of focus of object 515 in image 605c, and the like. If, as shown, a third image is to be selected, similar criteria may be used to select image 605d.

Processor circuit 530, as shown, is further configured to determine a level of clarity within a given region of particular ones of plurality of images 606. In some embodiments, processor circuit 530 identifies a clarity issue such as glare reflected off of object 515 within the given region. For example, to identify glare within a given region of image 605e, processor circuit 530 may be further configured to identify pixels in the given region that satisfy a threshold level of saturation. To distinguish glare from an area of object 515 that simply has a saturated color, processor circuit 530 may compare saturation levels of adjacent pixels, for example to identify a gradual increase in saturation that may occur as an amount of glare fades from a center point to regions without glare. In addition, processor circuit 530 may compare pixels in the same region in other ones of plurality of images 606. Such a process may be performed after an alignment process, such as is described above, is performed on plurality of images 606.

In some embodiments, processor circuit 530 may process at least one of images 605a-605d prior to the “capture image” option being selected. For example, processor circuit 530 may, starting with image 605a, pre-process an individual image 605 while video 501 is being recorded. Such pre-processing may include identifying object 515 by, for example, looking for recognizable text in image 605a. Once identified, pre-processing may further include aligning or otherwise adjusting object 515 within image 605a. For example, identified lines of text may be rotated such that they are aligned horizontally within image 605a. Pre-processing of images may reduce an amount of time used by computer system 100 to perform the described image clarity techniques.

It is noted that example 600 merely demonstrates the disclosed techniques, and is not intended to be limiting. In various embodiments, any suitable number of images may be included within a given recorded video. In addition, any suitable number of images may be selected for inclusion in the plurality of images to be used with the disclosed clarity techniques.

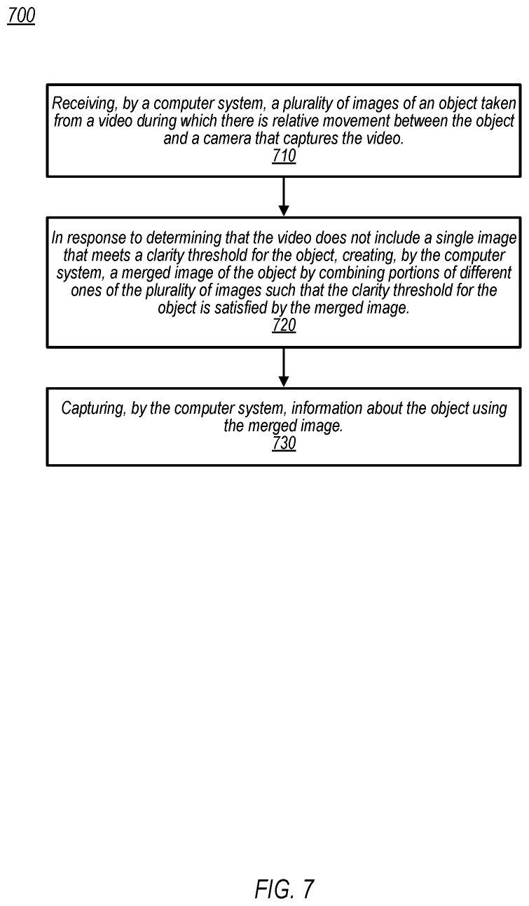

FIGS. 1-6 describe various aspects of improving clarity in captured images of an object. Such operations may be implemented using a variety of methods. FIGS. 7-9 describe several such methods.

Turning now to FIG. 7, a flow diagram of an embodiment of a method for increasing a level of clarity of captured images is depicted. In various embodiments, method 700 may be performed by computer system 100 in FIGS. 1, 2, and 5 to identify clarity issues, for example, in images 105 and create a merged image 110 that satisfies a threshold level of clarity. For example, computer system 100 may include (or have access to) a non-transitory, computer-readable medium having program instructions stored thereon that are executable by the computer system to cause the operations described with reference to FIG. 7. Referring collectively to FIGS. 5, 6, and 7, method 700 begins with block 710.

At block 710, method 700 includes receiving, by computer system 100, a plurality of images 605 of object 515 taken from video 501 during which there is relative movement between object 115 and camera 520 that captures video 501. For example, recording of video 501 may begin in response to a user of computer system 100 selecting an option to use a camera circuit to enter information into an application running on computer system 100. Video recording may continue until the user indicates that an image of object 515 is ready to be captured. Video recording may end after the indication is detected by the application. During the recording, the user may, on purpose, or inadvertently, move camera 520 and/or object 515, resulting in the disclosed movement between object 115 and camera 520.

Method 700 further includes at block 720, in response to determining that video 501 does not include a single image 605 that meets a clarity threshold for object 515, creating, by computer system 100, a merged image of object 515 by combining portions of different images 605 of plurality of images 606 such that the clarity threshold for object 515 is satisfied by the merged image. As shown, computer system 100 selects a portion of images 605 as the plurality of images 606 used to generate the merged image. As described above, computer system 100 may select one or more frames of video 501 for initial processing, starting, for example, from a last frame (image 605e) of video 501. Computer system 100 may use one or more techniques to determine if a clarity issue exists in image 605e. For example, if text is being recognized from object 515, then computer system 100 may perform an initial text recognition process. If all data being requested by the application can be successfully recognized from image 605e, then no further processing may be necessary.

Otherwise, if some of the requested information is incomplete (e.g., not recognizable in object 515) then computer system 100 may perform further processing to identify a clarity issue in image 605e. Computer system 100 may first perform the text recognition process on one more other ones of plurality of images 606. If none of the processed ones of plurality of images 606 can provide all the information requested by the application, then computer system 100 may further compare image 605e to other ones of plurality of images 606 (e.g., image 605c) to detect differences. Such a comparison may be performed after an alignment process has been performed on processed images such that any detected differences may be attributed to one or more clarity issues in the images. Computer system 100 may further compare pixel data in the areas where differences are detected. For example, glare off of object 515 may result in saturation (e.g., a bright spot with pixel data near a white color). Differences between the processed plurality of images 606 indicating a bright spot in different locations in the different images may suggest movement of a glare across object 515.

As illustrated, a clarity issue is present in the various ones of the plurality of images 606, the clarity issue appearing in a different region of object 515 in each image 605 of the plurality. Using pixel data from corresponding regions of other ones of images 605, features of object 515 that are obscured in each of the plurality of images 606 may be recaptured by replacing or adjusting pixel data in the obscured regions. For example, in the case of glare as described, pixel data values with high saturation values in a region with an identified clarity issue may be given a low weight value when merged with corresponding pixel values in other images in which the clarity issue is not detected in the same region. In other embodiments, pixel data associated with a clarity issue may be discarded and replaced with pixel data from other images without the clarity issue in the same region. Accordingly, a merged image may be created with a reduction of clarity issues such that information may be captured accurately from object 515.

Method 700 at block 730 includes capturing, by computer system 100, information about object 515 using the merged image. As illustrated, various pieces of information are available in object 515 that may be used in the application running on computer system 100. For example, object 515 includes a name an address as well as an alphanumeric value that may correspond to an ID number (e.g., driver's license or passport number), a credit or gift card number, or other such value. In addition, a graphic is included (represented by the cross-hatched area) that may, in some embodiments, include a barcode or QR-code that is readable by computer system 100. In other embodiments, the graphic area may correspond to a photo that may be used, for example, in a facial recognition operation, or a logo that may be used to identify a particular business or other type of entity associated with object 515.

By using a plurality of images in place of a single image, a success rate for capturing data from an object may be increased. Such an increase in the success rate may reduce a frustration level of users, as well as reduce a processing load on computer system 100. In addition, computer system 100 may, in some embodiments, utilize an online computer system for at least some of the image processing operations. Increasing a success rate for capturing data from an image may further reduce used bandwidth of a network used to communicate between computer system 100 and the online computer system.

It is noted that the method of FIG. 7 includes elements 710-730. In some cases, method 700 may be performed concurrently with other instantiations of the method. For example, two or more cores, or process threads in a single core, in computer system may each perform method 700 independently from one another, for example, on different pluralities of images that are captured at different times or at overlapping times from different camera circuits. Although three blocks are shown for method 700, additional blocks may also be included in other embodiments. For example, an additional block may include aligning object 515 between the different images 605. Method 700 may end in block 730 or may return to block 710 or 720 is the merged image is unable to satisfy the threshold level of clarity.

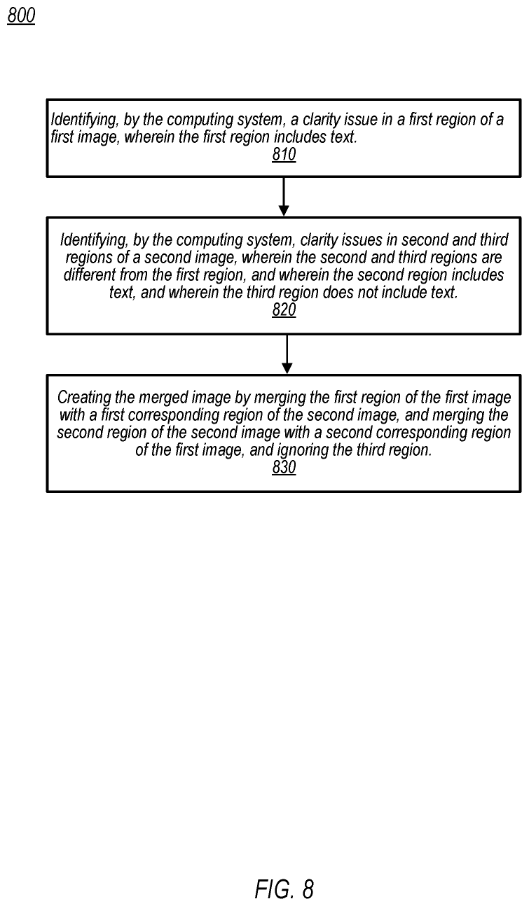

Proceeding now to FIG. 8, a flow diagram of an embodiment of a method for determining if an identified clarity issue may be ignored is depicted. In a similar manner as method 700, method 800 may be performed by computer system 100 in FIGS. 1, 2, and 5. In some embodiments, computer system 100 may include (or have access to) a non-transitory, computer-readable medium having program instructions stored thereon that are executable by the computer system to cause the operations described with reference to FIG. 8. Referring to FIGS. 1, 2, and 8, method 800 begins at block 810 after computer system 100 has received a plurality of images, including images 205a and 205b.

At block 810, method 800 includes identifying, by computer system 100, a first clarity issue in regions 230a and 236 of image 205a. Computer system 100 may utilize any suitable technique for identifying a clarity issue in image 205a. As described above, computer system 100 may capture images 205a and 205b as part of a data entry technique to capture information from object 215 and enter the data into a particular application. Computer system 100 may first attempt to extract information from image 205a, e.g., by performing a text recognition process or by decoding a bar code or QR code found in image 205a. If the extracted information is incomplete, then computer system 100 may attempt to identify if one or more clarity issues are present in image 205a. In particular, computer system 100 may look for clarity issues adjacent to recognized text, bar codes, QR codes, and the like. For example, computer system 100 may look for regions of image 205a that have at least a particular number of adjacent pixels that have indications of exceeding a threshold level of saturation, which may be indicative of an area with a glare.

In other embodiments, computer system 10 may attempt to identify clarity issues before any text or code recognition is performed. Computer system 100 may, for example, scan through rows and columns of pixel data of image 205a looking for indications of a clarity issue such as glare or shadows. Glare may be identified as a region of image 205a in which a group of adjacent pixels have a greater than threshold level of saturation (e.g., a bright spot). Conversely, a shadow may be identified as a region of image 205a in which a group of adjacent pixels have a lower than threshold level of saturation (e.g., a dark spot). In such regions, a lack of contrast between a pixel included in a symbol (e.g., a text character) and an adjacent pixel included in the background of object 215, may make character recognition inaccurate or impossible to perform. In the present example, computer system identifies region 230a as a clarity issue due to a determination that pixel data for at least a predetermined number of adjacent pixels exceeds a threshold level of saturation, indicative of glare.

Computer system 100 may further determine whether region 230a includes text, bar codes, QR codes, or similar symbols. To determine if region 230a includes text, for example, computer system 100 may perform one or more character recognition operations on symbols identified around the clarity issue. As shown, computer system 100 recognizes characters and, therefore, identifies region 230a as a region in which to perform clarity improvements. Computer system 100 may further determine that region 236 of image 205a also includes pixel data for at least a predetermined number of adjacent pixels that exceeds a threshold level of saturation. Using the text recognition process on the line of text below region 236, computer system 100 may determine that the text appears complete and may find no additional evidence of text or symbols being obscured in region 236. Accordingly, region 230a may be logged as a potential clarity issue while region 236 is not.

Method 800 further includes, at block 820, identifying, by computer system 100, clarity issues in regions 230b and 236 of image 205b, region 230b being different from region 230a and region 236 being the same in both images. As shown, computer system 100 uses a technique such as described for block 810 to identify regions 230b and 236. After identifying regions 230b and 236, computer system 100 determines that region 230b includes text, while region 236 does not include text. Accordingly, computer system 100 identifies region 230b as a region in which to perform clarity improvements, while region 236 is not identified as a region in which to perform clarity improvements.

To identify the potential clarity issues identified in regions 230a and 230b, computer system 100 may draw a bounding box around each of regions 230a and 230b within the respective images 205a and 205b. In some embodiments, these bounding boxes may be implemented in a new layer of the respective images 205 such that the underlying pixel data is not altered. The new layer may reuse pixel coordinate references from each of images 205a and 205b, allowing computer system 100 to easily identify pixels falling within regions 230a and 230b. For example, pixels, as shown, are referenced by row and column numbers. Row zero, column zero may reference the top-most, left-most pixel in the images, as well as in any additional layers added to the images.

Method 800 at block 830 includes creating, by computer system 100, merged image 210 by merging region 230a of image 205a with corresponding region 232a of image 205b, and merging region 230b of image 205b with corresponding region 232b of image 205a. As shown, computer system 100 may identify corresponding region 232a in image 205b after an alignment process is performed on images 205a and 205b to align elements in each image with each other. By aligning the two different images 205a and 205b, corresponding regions can be identified using the same pixel coordinate references between the two images. Any adjustments made to align the pixel coordinates between the two images may be applied to all layers within each image. Accordingly, coordinates of the respective bounding boxes for each of regions 230a and 230b may be used to identify corresponding regions 232a and 232b in images 205b and 205a, respectively.

Computer system 100 may determine that corresponding region 232a meets the threshold level of clarity and, therefore, pixel data from corresponding region 232a may be used to modify pixel values in region 230a. In a similar manner, corresponding region 232b is identified in image 205a and is determined to be usable to modify pixel values in region 230b. Computer system 100 may further ignore region 236 in response to determining that no text or other decipherable symbols are included in region 236. Merged image 210 may then be generated using the combination of pixel data from images 205a and 205b, as described.

It is noted that the method of FIG. 8 includes elements 810-830. In some cases, method 800 may be performed as a portion of method 700, such as block 720. Method 800 may end in block 830, or in some embodiments, be repeated to identify further clarity issues in images 205a and/or 205b. For example, a character recognition process may fail to recognize characters in a particular region of merged image 210. In response, method 800 may be repeated to identify additional clarity issues in the particular region. Threshold levels for determining clarity may be adjusted when method 800 is repeated in such a manner.

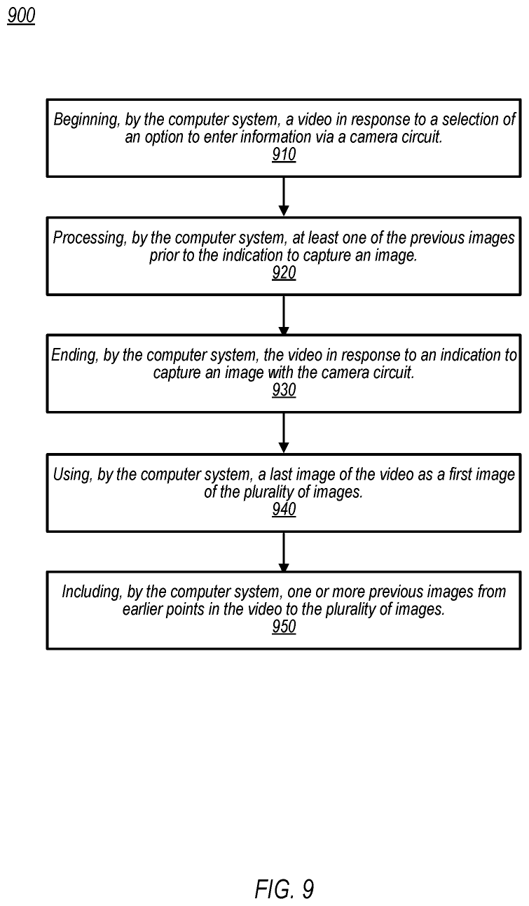

Moving to FIG. 9, a flow diagram of an embodiment of a method for capturing a plurality of images using a video is depicted. Method 900 may be performed by computer system 100, as shown in FIGS. 1, 2, and 5 to generate plurality of images 606 from video 501. As described above, computer system 100 may include (or have access to) a non-transitory, computer-readable medium having program instructions stored thereon that are executable by the computer system to cause the operations described with reference to FIG. 9. Referring collectively to FIGS. 5, 6, and 9, method 900 begins in block 910.

Block 910 of method 900 includes beginning, by computer system 100, video 501 in response to a selection of a “use camera” one of options 560 to enter information via camera 520. An application running on computer system 100 may prompt a user to enter one or more pieces of information. This app may present the user with options for how the information can be entered, including by type the information into the application or by using a camera to take a picture of object 515 that includes the pertinent information in a text or other symbolic format, such as barcode or QR-code. After determining that the user selected the “use camera” option, computer system 100 enables camera 520 to begin recording video 501.

At block 920, method 900 includes processing, by computer system 100, at least one of images 605 prior to an indication to capture an image from the user. As illustrated, camera 520, while recording, captures a series of images 605, each one of images 605 corresponding to one frame of video 501. At least some of images 605 are displayed, in an order they are captured, on display 510, allowing the user to see how object 515 is depicted in the view of camera 520. To reduce an amount of time that computer system 100 may use to capture the input information from object 515, computer system 100 may begin to process one or more of images 605 after they are captured, and while subsequent images 605 are yet to be captured. For example, image 605a may be processed while camera 520 is capturing image 605c, and prior to images 605d and 605e being captured. This processing may include one or more pre-processing steps, such as centering object 515 within the boundaries of image 605a, adjusting a rotational offset of object 515, and/or performing initial character recognition procedures.

Method 900 also includes, at block 930, ending, by computer system 100, recording of video 501 in response to an indication to capture an image with camera 520. As illustrated, the application may present “capture image” option 562 on display 510 in a manner that suggest to the user that a photograph will be taken in response to the user selecting option 562. Computer system 100, in response to determining that option 562 has been selected, may cease recording video 501. If a final frame of video 501 (e.g., image 605e) is still being captured, then camera 520 may complete the capture of image 605e prior to video 501 being completed. In some embodiments, a predetermined number of frames of video 501 may continue to be captured after option 562 has been selected. For example, in response to detecting the indication that option 562 has been selected, camera 520 may capture one or two additional frames of video 501.

At block 940, method 900 includes using, by computer system 100, a last image of video 501 as a first image of plurality of images 606. As illustrated, the user may select option 562 to “capture image” in response to seeing a satisfactory depiction of object 515 in display 510 just prior to and/or while selecting option 562. Accordingly, the final frames of video 501 may be expected to include the clearest images of object 515. Computer system 100, therefore, selects a final frame (e.g., image 605e) as a first image for inclusion to plurality of images 606. Plurality of images 606 include two or more images that may be merged to create the merged image, if necessary. It is noted that, in some cases, image 605e may not include any clarity issues, and as a result, creation of a merged image may not be needed. Instead, image 605e may be used for capturing information for use in the application. As shown, however, image 605e, as well as the other images 605 each include a clarity issue, and a merged image is, therefore, generated.

In addition, method 900 includes, at block 950, including one or more previous images 605 from earlier points in video 501 to plurality of images 606. As described, a merged image will be created to overcome clarity issues in the various frames of video 501. Since camera 520 may capture video at multiple frames per second (e.g., 60 or 120 frames per second), video 501 may include tens, hundreds, or even thousands of individual frames. Processing all such frames may be a burden to processing circuit 530 of computer system 100. Accordingly, a subset of the captured frames may be selected as plurality of images 606. In some embodiments, a predetermined number of the final frames may be selected. As shown, images 605d and 605c, which immediately precede image 605e, are selected. In other embodiments, however, a certain number of frames may be skipped between selected images 605. For example, if a 60 frames per second recording rate is used, then fourteen frames of video 501 may be skipped, and the fifteenth frame before the final frame, representing one-fourth of a second between frames, may be selected. This may repeat two more times to select four images 605 in total, each captured a quarter of a second apart over the final second of the video 501 recording. Such a distribution of selected images may increase a likelihood of movement occurring between camera 520 and object 515 over the course of the time period. It is noted that, in other embodiments, different numbers of frames may be skipped and different time periods over which selected frames are selected may be used.

The method may end in block 950 and computer system 100 may proceed to perform, for example, method 700 to process the plurality of images 606. In other embodiments, the application may present a “retake image” option after the user selects the “capture image” option, allowing the user to retake the video if the user is not satisfied with the current result. In such a case, method 900 may return to block 910 to repeat the video capturing process.

It is noted that the method of FIG. 9 includes elements 910-950. In a similar manner as method 700, different instances of method 900 may be performed by one or more processor cores in the computer system to capture multiple videos if, for example, multiple cameras are included in the computer system. Although five blocks are shown for method 900, additional blocks may also be included in other embodiments. For example, an additional block may include setting particular video options for camera 520 to capture video 501.

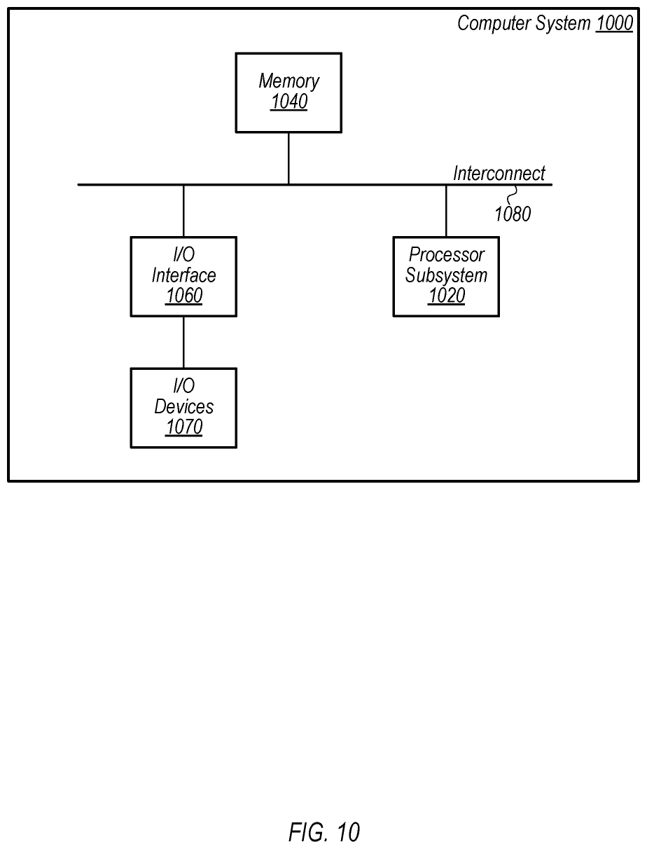

In the descriptions of FIGS. 1-9, various computer systems, mobile devices, computer services, and the like have been disclosed. Such devices may be implemented in a variety of manners. FIG. 10 provides an example of a computer system that may correspond to one or more of the disclosed devices, such as computer system 100 in FIGS. 1, 2, and 5.

Referring now to FIG. 10, a block diagram of an example computer system 1000 is depicted. Computer system 1000 includes a processor subsystem 1020 that is coupled to a system memory 1040 and I/O interfaces(s) 1060 via an interconnect 1080 (e.g., a system bus). I/O interface(s) 1060 is coupled to one or more I/O devices 1070. Computer system 1000 may be any of various types of devices, including, but not limited to, a server computer system, personal computer system, desktop computer, laptop or notebook computer, mainframe computer system, server computer system operating in a datacenter facility, tablet computer, handheld computer, smartphone, workstation, network computer, etc. Although a single computer system 1000 is shown in FIG. 10 for convenience, computer system 1000 may also be implemented as two or more computer systems operating together.

Processor subsystem 1020 may include one or more processors or processing units. In various embodiments of computer system 1000, multiple instances of processor subsystem 1020 may be coupled to interconnect 1080. In various embodiments, processor subsystem 1020 (or each processor unit within 1020) may contain a cache or other form of on-board memory.

System memory 1040 is usable to store program instructions executable by processor subsystem 1020 to cause computer system 1000 perform various operations described herein. System memory 1040 may be implemented using different physical, non-transitory memory media, such as hard disk storage, floppy disk storage, removable disk storage, flash memory, random access memory (RAM—SRAM, EDO RAM, SDRAM, DDR SDRAM, LPDDR SDRAM, etc.), read-only memory (PROM, EEPROM, etc.), and so on. Memory in computer system 1000 is not limited to primary storage such as system memory 1040. Rather, computer system 1000 may also include other forms of storage such as cache memory in processor subsystem 1020 and secondary storage on I/O devices 1070 (e.g., a hard drive, storage array, etc.). In some embodiments, these other forms of storage may also store program instructions executable by processor subsystem 1020.

I/O interfaces 1060 may be any of various types of interfaces configured to couple to and communicate with other devices, according to various embodiments. In one embodiment, I/O interface 1060 is a bridge chip (e.g., Southbridge) from a front-side to one or more back-side buses. I/O interfaces 1060 may be coupled to one or more I/O devices 1070 via one or more corresponding buses or other interfaces. Examples of I/O devices 1070 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 1070 includes a network interface device (e.g., configured to communicate over WiFi, Bluetooth, Ethernet, etc.), and computer system 1000 is coupled to a network via the network interface device.

### ***

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

### ***

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]— is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

### ***

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A method, comprising:
receiving, by a computer system, a plurality of images of an object taken from a video during which there is relative movement between the object and a camera that captures the video;
in response to determining that the video does not include a single image that meets a clarity threshold for the object, creating, by the computer system, a merged image of the object by combining portions of different images of the plurality of images such that the clarity threshold for the object is satisfied by the merged image; and
capturing, by the computer system, information about the object using the merged image.

2. The method of claim 1, wherein creating the merged image includes:
identifying, by the computer system, a first clarity issue in a first region of a first image;
identifying, by the computer system, a second clarity issue in a second region of a second image, the second region different from the first region; and
creating the merged image by merging the first region of the first image with a first corresponding region of the second image, and merging the second region of the second image with a second corresponding region of the first image.

3. The method of claim 2, wherein identifying clarity issues in a given region includes:
determining, by the computer system, whether the given region includes text; and
ignoring the given region in response to determining that no text is included in the given region.

4. The method of claim 1, wherein one or more clarity issues include glare reflected off of the object.

5. The method of claim 1, further comprising performing, by the computer system, one or more alignment operations to align the object in the different images.

6. The method of claim 5, wherein performing the one or more alignment operations includes:
performing optical character recognition in the different images to generate character data; and
using the character data to align the different images.

7. The method of claim 1, further comprising:
beginning the video in response to a selection of an option to enter information via a camera circuit; and
ending, by the computer system, the video in response to an indication to capture an image with the camera circuit.

8. The method of claim 7, further comprising:
using, by the computer system, a last image of the video as a first image of the plurality of images; and
including, by the computer system, one or more previous images from earlier points in the video to the plurality of images.

9. The method of claim 8, further comprising processing, by the computer system, at least one of the one or more previous images prior to the indication to capture an image.

10. The method of claim 1, wherein creating the merged image includes increasing a level of contrast between pixels with light image data and pixels with dark pixel data.

11. A non-transitory computer-readable medium having instructions stored thereon that are executable by a computer system to perform operations comprising:
receiving, from a camera circuit, a series of images from a video taken of an object during which there is relative movement between the object and the camera circuit;
determining a level of clarity of the object within individual images of the series of images;
in response to determining that the individual images fail to meet a threshold level of clarity of the object, combining portions of two or more of the individual images to generate a merged image of the object; and
extracting information about the object using the merged image.

12. The non-transitory computer-readable medium of claim 11, further comprising selecting the two or more individual images by:
identifying a clarity issue in a first region of a first image of the series of images;
identifying a second image of the series of images in which the level of clarity of the object within a first corresponding region meets the threshold level of clarity; and
combining the first corresponding region with the first region in the merged image.

13. The non-transitory computer-readable medium of claim 12, wherein identifying the second image includes:
performing an alignment operation of the second image relative to the first image; and
identifying the first corresponding region using a location of the first region.

14. The non-transitory computer-readable medium of claim 13, wherein performing the alignment operation includes:
performing optical character recognition in the first and second images to generate character data; and
using the character data to align the object in the second image to the location of the object in the first image.

15. The non-transitory computer-readable medium of claim 11, wherein determining the level of clarity of the object includes:
determining if a given region of a particular image includes text; and
indicating that the level of clarity of the given region meets the threshold level of clarity in response to determining that there is no text in the given region.

16. A system comprising:
a camera circuit configured to capture a series of images of a video of an object while there is movement between the camera circuit and the object;
a memory circuit configured to receive the series of images; and
a processor circuit configured to:
in response to a determination that individual images of the series of images fail to meet a threshold level of clarity of the object, combine portions of two or more of the individual images to generate a merged image of the object; and
extract information about the object using the merged image.

17. The system of claim 16, wherein the processor circuit is further configured to determine a level of clarity within a given region of a particular image by identifying glare reflected off of the object within the given region.

18. The system of claim 17, wherein the processor circuit is further configured to identify glare within the given region by identifying pixels in the given region that satisfy a threshold level of saturation.

19. The system of claim 16, wherein the processor circuit is further configured to perform one or more alignment operations to align the object in a first image relative to the object in a second image.

20. The system of claim 19, wherein to perform the one or more alignment operations, the processor circuit is configured to identify one or more portions of same text in the first and second images.
